(19) United States
(12) Patent Application Publication
(10) Pub. No.: US 2026/0142401 A1
(43) Pub. Date: May 21, 2026

(54) CABLE HARNESS

(71) Applicant: BIZLINK INTERNATIONAL CORP., New Taipei City (TW)

(72) Inventors: Hongping SU, New Taipei City (TW); Haoran ZOU, New Taipei City (TW)

(21) Appl. No.: 19/014,257

(22) Filed: Jan. 9, 2025

Related U.S. Application Data
(63) Continuation-in-part of application No. 18/948,557, filed on Nov. 15, 2024.

(51) Int. Cl. H01R 13/502; H01R 4/18

(52) U.S. Cl. CPC H01R 13/502; H01R 4/183

(57) ABSTRACT

A cable harness includes a connector, two terminal sets, a first cable module, and a second cable module. The two terminal sets are disposed in the cover plate. An end of the two terminal sets exposes via two openings of two extending portions of the cover plate respectively. The first cable module is electrically connected to one of the two terminal sets and embedded in a first space of an inner chamber of the cover plate and exposes via a first lateral opening of the first space. The second cable module is electrically connected to the other one of the two terminal sets and embedded in a second space of the inner chamber of the cover plate and exposes via a second lateral opening of the second space.

### CROSS-REFERENCE TO RELATED APPLICATION

This application is a Continuation-in-part of U.S. application Ser. No. 18/948,557, filed on Nov. 15, 2024, which is herein incorporated by reference in its entirety.

### BACKGROUND

### Field of Invention

The present invention relates to a cable harness, and specifically, to a cable harness with connector act as a busbar clip.

### Description of Related Art

Generally, a busbar clip connector of a server includes two conductive terminal sets that are in contact with the copper busbar. For example, BzLisa 600S power connector of BizLink discloses a connector including a main body, a first grounded terminal and a second grounded terminal disposed on the main body, and a first power terminal and a second power terminal fixedly disposed inside the main body. To improve the capability of BzLisa 600S conducting larger current and heat dissipation, improvement shall be needed.

Proposing a cable harness that can address the above challenges remains a critical focus for industry investment in research and development.

### SUMMARY

In view of this, one purpose of the present disclosure is to provide a cable harness that can solve the aforementioned problems.

In order to achieve the above objective, according to an embodiment of the present disclosure, a cable harness includes a connector, two terminal sets, a first cable module, and a second cable module. The two terminal sets are disposed in a cover plate. An end of the two terminal sets exposes via two openings of two extending portions of the housing respectively. The first cable module is electrically connected to one of the two terminal sets and embedded in a first space of an inner chamber of the housing and exposes via a first lateral opening of the first space. The second cable module is electrically connected to the other one of the two terminal sets and embedded in a second space of the inner chamber of the housing and exposes via a second lateral opening of the second space.

In summary, in the cable harness of the present disclosure, since the two terminal sets expose via the first lateral opening and the second lateral opening respectively, the purpose of improving the dissipation efficiency can be well achieved.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of a cable harness in accordance with an embodiment of the present disclosure;

FIG. 2 is an exploded view of the cable harness in accordance with an embodiment of the present disclosure;

FIG. 3 is a perspective view of a terminal in accordance with an embodiment of the present disclosure;

FIG. 4 is an exploded view of the terminal in accordance with an embodiment of the present disclosure;

FIG. 5 is a sided view of the terminal in accordance with an embodiment of the present disclosure;

FIG. 6 is a sided view of the cable harness in accordance with an embodiment of the present disclosure;

FIG. 7 is another sided view of the cable harness in accordance with an embodiment of the present disclosure;

FIG. 8 is a cross-sectional view of the cable harness in accordance with an embodiment of the present disclosure; and

FIG. 9 is a perspective view of the cable harness in accordance with an embodiment of the present disclosure.

### DETAILED DESCRIPTION

Hereinafter, a plurality of embodiments of the present disclosure will be disclosed in diagrams. For the sake of clarity, many details in practice will be described in the following description. However, it should be understood that these details in practice should not limit present disclosure. In other words, in some embodiments of present disclosure, these details in practice are unnecessary. In addition, for simplicity of the drawings, some conventionally used structures and elements will be shown in a simple schematic manner in the drawings. The same reference numbers are used in the drawings and the description to refer to the same or like parts.

Hereinafter, the structure and function of each component included in the cable harness CA of this embodiment and the connection relationship between the components will be described in detail.

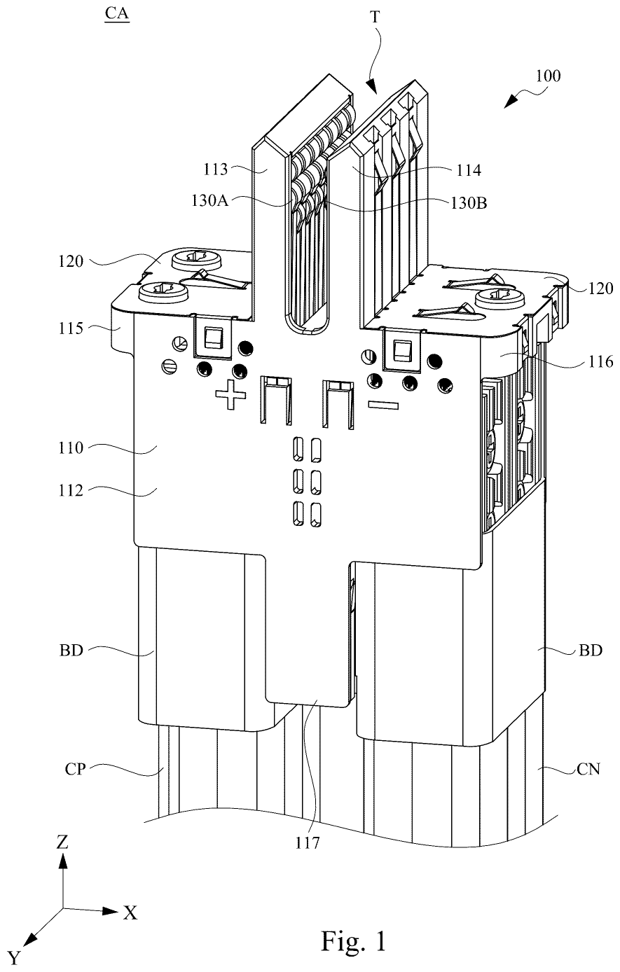

Reference is made to FIG. 1. FIG. 1 is a perspective view of a cable harness CA in accordance with an embodiment of the present disclosure. As shown in FIG. 1, in this embodiment, the cable harness CA is for providing power to a server, the cable harness CA includes two connectors 100 connects with a cable.

In the present embodiment, the cable assembly CA comprises a connector 100, a positive cable module CP, and a negative cable module CN.

The connector 100 includes a housing 110, two grounding terminals 120, a positive terminal set 130A, and a negative terminal set 130B.

The housing 110 is one piece formed by molding, with an insulating material. The housing includes the following portions of two cover plates 112, two extending portions 113, 114, two wing portions 115, 116, two extending plates 117, and a partition plate 118. The cover plates 112, the extending portions 113, 114, and the wing portions 115, 116 commonly define an inner chamber with two lateral openings LO1, LO2.

As depicted in FIG. 1, the first extending portion 113 and the second extending portion 114 protrude from a top of the cover plate 112 along a direction (e.g., z-direction). The first extending portion 113 is separated from the second extending portion 114 by a trench T. Each of the first extending portion 113 and the second extending portion 114 has a opening opposite and facing to each other respectively for allowing at least a portion of the terminal sets 130A, 130B to be exposed therethrough. The wing portion 115 and the wing portion 116 laterally extend from the first and second extending portions 113, 114 and are perpendicular thereto.

The two extending plates 117 are connected to a bottom end of the two cover plates 112 respectively and extend toward the opposite side of the extending portions 113, 114 along the z-direction.

As shown in FIG. 1, in this embodiment, the two grounding terminals 120 are respectively disposed on an outside surface of the first extending portion 113 and the second extending portion 114. The two grounding terminals 120 may be formed of, for example, a metallic material, an alloy material, or other suitable materials.

The partition plate 118 connects both of the cover plates 112 and is disposed in the inner chamber of the housing 110, and a portion of the partition plate 118 protrudes beyond the cover plates 112 and has covered by the extending plates 117, which the partition plate 118 terminates at the rear end of the extending plates 117.

The partition plate 118 connects with the two cover plates 112 and the two extending plates 117 and separates the inner chamber of the housing 110 into a first space S1 and a second space S2 for accommodating the positive terminal set 130A and the negative terminal set 130B. More specifically, the first space S1 is defined by at least two of the cover plates 112, the wing portion 115, the two extending plates 117, and the partition plate 118. The first space S1 is interconnected with the opening of the first extending portion 113, whereas the second space S2 is interconnected with the opening of the second extending portion 114.

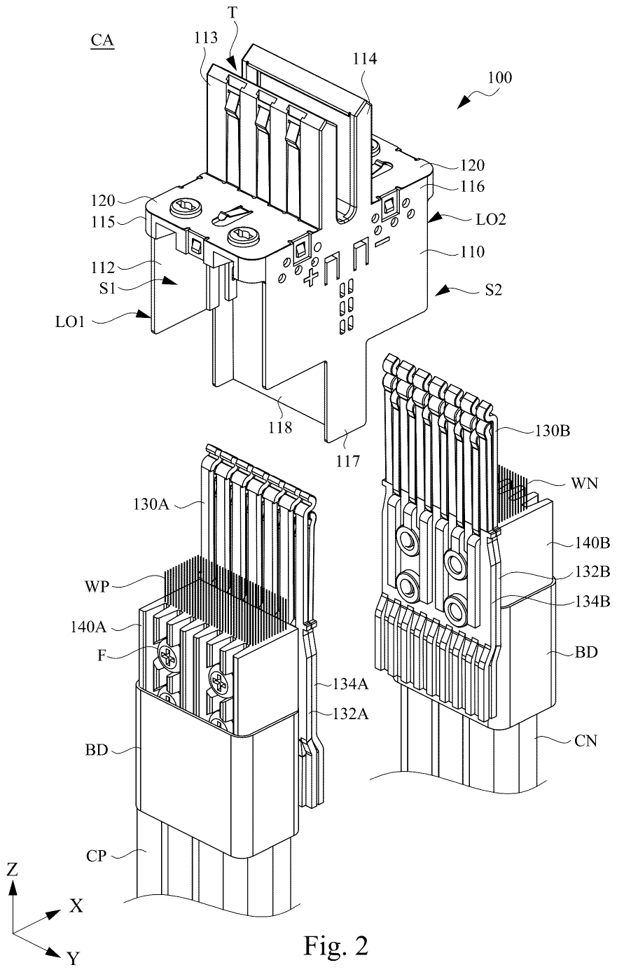

Reference is made to FIG. 2. FIG. 2 is an exploded view of the cable harness CA in accordance with an embodiment of the present disclosure. As shown in FIG. 2, in this embodiment, the positive terminal set 130A includes an outer terminal plate 132A, an inner terminal plate 134A, a wire fixing module 140A, an isolating sleeve BD and at least one fixing part set F composed of, for example, at least one screw (e.g., stud) with screw cap (e.g., nut), or rivet. Another fixing part sets F are further configured to secure the negative terminal set 130B with the wire fixing module 140B.

Each of the wire fixing module 140A, 140B comprises a deformable metal crimping ring and at least one heat sink (heat fin module). In the embodiment depicted in FIG. 2, the heat fin module and the crimping ring is two separated components, however, the heat fin module can also be one piece formed with the crimping ring if needed.

The outer terminal plate 132A and the inner terminal plate 134A are stacked with each other and secured with two screws penetrating the heat sink, the crimping ring, the wire core in the crimping ring, and the through holes of both of the outer terminal plate 132A and the inner terminal plate 134A.

The outer terminal plate 132A is connected to the positive cable module CP, so that the outer terminal plate 132A is located between the positive cable module CP and the inner terminal plate 134A. The negative terminal set 130B includes an outer terminal plate 132B and an inner terminal plate 134B. The outer terminal plate 132B and the inner terminal plate 134B are stacked with each other. The outer terminal plate 132B is connected to the negative cable module CN, so that the outer terminal plate 132B is located between the negative cable module CN and the inner terminal plate 134B.

In some embodiments, the terminal plates in the positive terminal set 130A and the negative terminal set 130B may be, for example, brass or other suitable conductive materials.

As shown in FIG. 2, the positive cable module CP and the negative cable module CN respectively include a plurality of positive wires WP and a plurality of negative wires WN. A portion of the positive wires WP and a portion of the negative wires WN respectively protrude from the wire fixing module 140A and the wire fixing module 140B. As shown in FIG. 1 and FIG. 2, the inner terminal plate 134A of the positive terminal set 130A and the inner terminal plate 134B of the negative terminal set 130B face to each other in the trench T. In some embodiments, the positive wires WP and the negative wires WN are core wires.

As shown in FIG. 2, in some embodiments, the first space S1 has a first lateral opening LO1 and the second space S2 has a second lateral opening LO2.

In some embodiments, an end of the positive wires WP extends beyond the wire fixing module 140A and is exposed via the first lateral opening LO1, and an end of the negative wires WN extends beyond the wire fixing module 140B and is exposed via the second lateral opening LO2.

The heat fins of the wire fixing module 140A are secured on a surface of the first crimping ring facing the first lateral opening LO1 by the fixing part sets F. The heat fins of the wire fixing module 140B are secured on a surface of the second crimping ring facing the second lateral opening LO2 by the another fixing part sets F. The heat fins of the wire fixing module 140A and the heat fins of the wire fixing module 140B are exposed via the first lateral opening LO1 and the second lateral opening LO2, respectively.

As shown in FIG. 1, in this embodiment, the positive cable module CP is electrically connected to the positive terminal set 130A, and the negative cable module CN is electrically connected to the negative terminal set 130B. In this embodiment, the cable harness CA further includes two isolating sleeves BD. One of the two isolating sleeves BD is connected to the positive cable module CP, and the other one of the two isolating sleeves BD is connected to the negative cable module CN. In some embodiments, the positive cable module CP and the negative cable module CN are bound with the two isolating sleeves BD.

In some embodiments, the isolating sleeves BD cover at least one portion of cables of the positive cable module CP, the wire fixing module 140A, at least one portion of cables of the negative cable module CN, and the wire fixing module 140B.

In some embodiments, the partition plate 118 extends away from the first extending portion 113 and the second extending portion 114 and separates the wire fixing module 140A from the wire fixing module 140B.

In some embodiments, the two extending plates 117 extend from the cover plate 112 toward a direction away from the first extending portion 113 and the second extending portion 114. The two extending plates 117 are connected to and cover the whole of partition plate 118. The two extending plates 117 and the partition plate 118 protrude beyond the cover plate 112 and over half of the isolating sleeves BD.

In some embodiments, the housing 110 includes two extending plates 117 extending from the cover plate 112 toward a direction away from the first extending portion 113 and the second extending portion 114. As shown in FIG. 2, the two extending plates 117 are connected to both sides of the partition plate 118 to form an H-shaped structure. The two extending plates 117 and the partition plate 118 extend beyond the whole of the wire fixing module 140A and the wire fixing module 140B. In some other embodiments, the connector 100 does not include the extending plate 117, so that the bottom portion of the positive terminal set 130A and the bottom portion of the negative terminal set 130B are fully exposed.

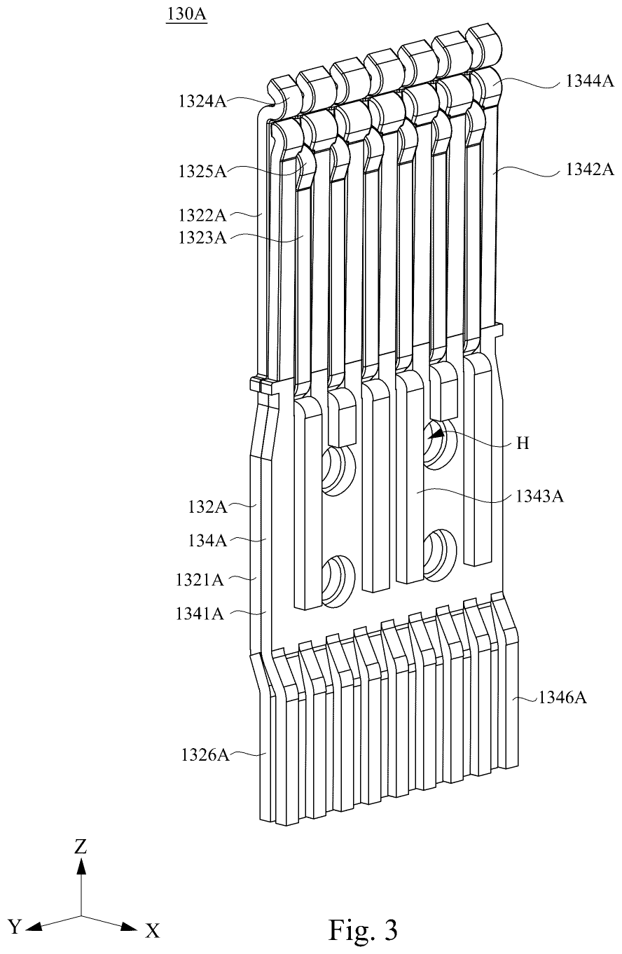

Reference is made to FIG. 3. FIG. 3 is a perspective view of the positive terminal set 130A in accordance with an embodiment of the present disclosure. It is noted that the structural configuration of the positive terminal set 130A is substantially the same as the structural configuration of the negative terminal set 130B. For simplicity, the present disclosure only discusses the positive terminal set 130A in detail and omits the negative terminal set 130B. As shown in FIG. 3, in this embodiment, the positive terminal set 130A (or the negative terminal set 130B) includes the outer terminal plate 132A and the inner terminal plate 134A combined with the outer terminal plate 132A. The outer terminal plate 132A includes an outer fixing portion 1321A, a plurality of first elastic arm 1322A, a plurality of second elastic arm 1323A, a plurality of first contacting portions 1324A, a plurality of second contacting portions 1325A, and a plurality of first dissipation fins 1326A. The first elastic arms 1322A and the second elastic arms 1323A are extended from the outer fixing portion 1321A. The first contacting portions 1324A are individually bent from the first elastic arms 1322A. In some embodiments, the first contacting portions 1324A are located at an end of the first elastic arms 1322A away from the cover plate 112 of the housing 110. The second contacting portions 1325A are individually bent from the second elastic arms 1323A. In some embodiments, the second contacting portions 1325A are located at an end of the second elastic arms 1323A away from the cover plate 112 of the housing 110.

Reference is made again to FIG. 3. As shown in FIG. 3, in this embodiment, the inner terminal plate 134A includes an inner fixing portion 1341A, a plurality of third elastic arm 1342A, a plurality of extruded portions 1343A, a plurality of third contacting portions 1344A, and a plurality of second dissipation fins 1346A. The third elastic arms 1342A are extended from the inner fixing portion 1341A. The extruded portions 1343A are extended and bent from the inner fixing portion 1341A. In some embodiments, the extruded portions 1343A are raised above the inner fixing portion 1341A. The third contacting portions 1344A overlap with the first elastic arms 1322A. The third contacting portions 1344A are individually bent from the third elastic arms 1342A. In some embodiments, the third contacting portions 1344A are located at an end of the third elastic arms 1342A away from the cover plate 112 of the housing 110. In some embodiments, the first contacting portions 1324A, the second contacting portions 1325A, and the third contacting portions 1344A are individually and parallelly arranged in a direction (e.g., y-direction). As shown in FIG. 3, the positive terminal set 130A has a plurality of fixing holes H. The fixing holes H are configured to be coupled to the fixing part sets F.

In some embodiments, the quantity of the first elastic arms 1322A, the second elastic arms 1323A, the third elastic arms 1342A, the first contacting portions 1324A, the second contacting portions 1325A, the third contacting portions 1344A, the first dissipation fins 1326A, and the second dissipation fins 1346A may be singular or plural. The present disclosure is not intended to limit the quantity of the first elastic arms 1322A, the second elastic arms 1323A, the third elastic arms 1342A, the first contacting portions 1324A, the second contacting portions 1325A, the third contacting portions 1344A, the first dissipation fins 1326A, and the second dissipation fins 1346A.

In some embodiments, the first dissipation fins 1326A is spaced apart from the second dissipation fins 1346A.

In some embodiments, the third elastic arms 1342A are separated by a plurality of gaps, and the extruded portions 1343A are connected to a root of the gaps and bent backward and pressed against the cover plate 112. The cover plate 112 connects the third elastic arms 1342A and the second dissipation fins 1346A at both ends thereof.

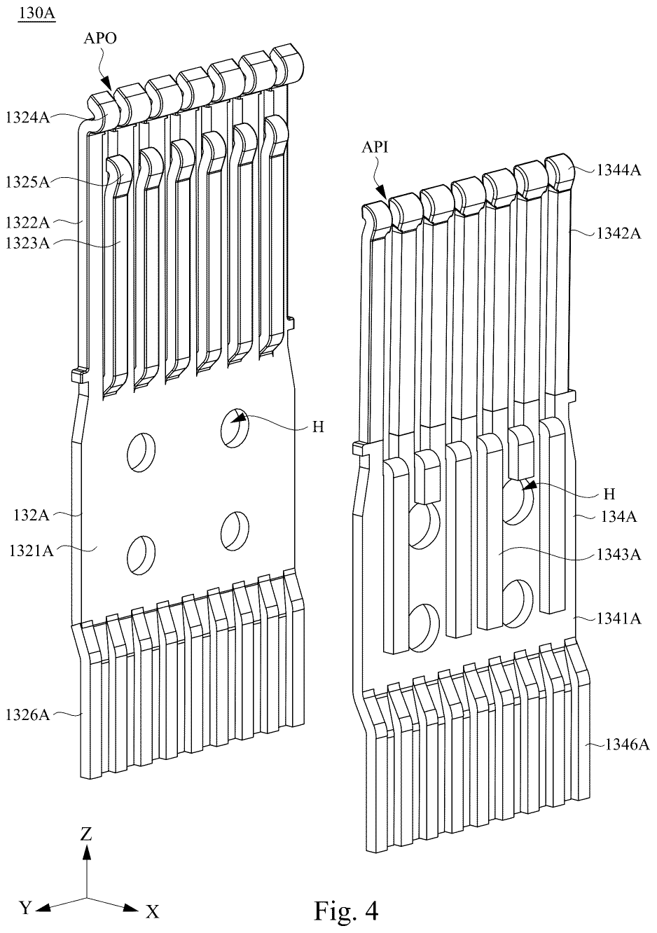

FIG. 4 is an exploded view of the positive terminal set 130A in accordance with an embodiment of the present disclosure. As shown in FIG. 4, in this embodiment, the second elastic arms 1323A are individually separated from the first elastic arms 1322A. The first dissipation fins 1326A are separated from the first elastic arms 1322A and the second elastic arms 1323A. More specifically, the first elastic arms 1322A and the second elastic arms 1323A are located at a top end of the outer terminal plate 132A, whereas the first dissipation fins 1326A are located at a bottom end of the outer terminal plate 132A. A plurality of outer apertures APO are formed between each two of the first elastic arms 1322A. In some embodiments, the second elastic arms 1323A are aligned with and cover a majority portion of the outer apertures APO. As shown in FIG. 2 and FIG. 4, in this embodiment, the first dissipation fins 1326A and the second dissipation fins 1346A protrude away from the bottom of the cover plate 112. The second contacting portions 1325A are separated from the first contacting portions 1324A. The second dissipation fins 1346A are separated from the third elastic arms 1342A. More specifically, the third elastic arms 1342A are located at a top end of the inner terminal plate 134A, whereas the second dissipation fins 1346A are located at a bottom end of the inner terminal plate 134A. A plurality of inner apertures API are formed between each two of the third elastic arms 1342A. In some embodiments, the second elastic arms 1323A are embedded into the inner apertures API respectively. As shown in FIG. 4, the outer terminal plate 132A has the fixing holes H, and the inner terminal plate 134A has the fixing holes H as well. It is noted that the outer terminal plate 132B and the inner terminal plate 134B of the negative terminal set 130B respectively have the fixing holes H.

In some embodiments, the second elastic arms 1323A are raised from the first elastic arms 1322A.

In some embodiments, the extruded portions 1343A correspond to the inner apertures API. In some embodiments, the extruded portions 1343A are located below the inner apertures API.

In some embodiments, an end of the outer terminal plate 132A and the inner terminal plate 134A forms the first dissipation fins 1326A and the second dissipation fins 1346A with multiple parallel grooves formed by a stamping process.

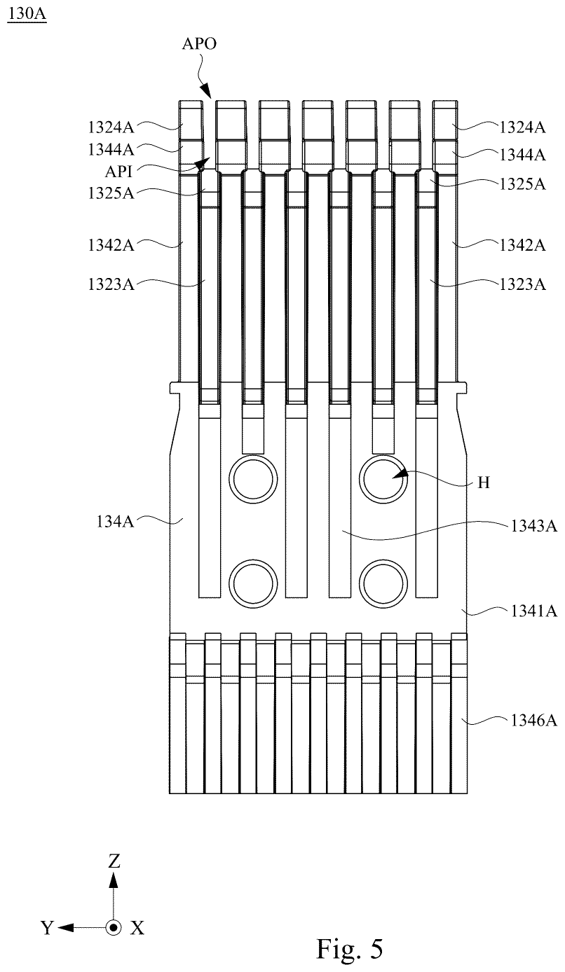

Reference is made to FIG. 5. FIG. 5 is a sided view of the positive terminal set 130A in accordance with an embodiment of the present disclosure. As shown in FIG. 5, in this embodiment, each of the second contacting portions 1325A is located between two of the adjacent first contacting portions 1324A. Each of the second contacting portions 1325A is located between two of the adjacent third contacting portions 1344A. As shown in FIG. 5, the fixing holes H of the outer terminal plate 132A are aligned with the fixing holes H of the inner terminal plate 134A. In some embodiments, a diameter of each of the fixing holes H of the outer terminal plate 132A is less than a diameter of each of the fixing holes H of the inner terminal plate 134A. In some embodiments, the inner apertures API are aligned with the outer apertures APO along a direction (e.g., x-direction).

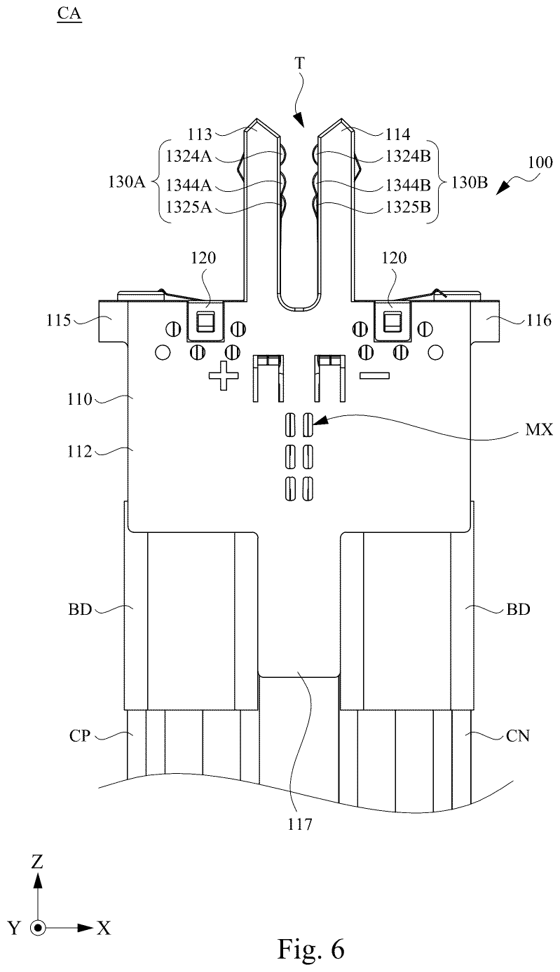

Reference is made to FIG. 6. FIG. 6 is a sided view of the cable harness CA in accordance with an embodiment of the present disclosure. As shown in FIG. 6, in this embodiment, the negative terminal set 130B includes a plurality of first contacting portions 1324B, a plurality of second contacting portions 1325B, and a plurality of third contacting portions 1344B. The first contacting portions 1324A correspond to the first contacting portions 1324B. The second contacting portions 1325A correspond to the second contacting portions 1325B. The third contacting portions 1344A correspond to the third contacting portions 1344B. As shown in FIG. 6, the third contacting portions 1344A are located between the first contacting portions 1324A and the second contacting portion 1325A. In some embodiments, the third contacting portions 1344A are located between the first contacting portions 1324A and the second contacting portion 1325A in a side view. More specifically, the side view is defined as a view being viewed along a direction which is coplanar with another direction from the first extending portion 113 to the second extending portion 114. In some embodiments, the side view may be a view which is viewed along a direction (e.g., y-direction) parallel to an xy-plane, as shown in FIG. 6. Similarly, the third contacting portions 1344B are located between the first contacting portions 1324B and the second contacting portion 1325B in the side view as shown in FIG. 6. The first contacting portions 1324A, the second contacting portions 1325A, and the third contacting portions 1344A are raised away from the first extending portion 113. The first contacting portions 1324B, the second contacting portions 1325B, and the third contacting portions 1344B are raised away from the second extending portion 114.

In some embodiments, the cover plates 112 has a through hole matrix MX for allowing air to pass therethrough.

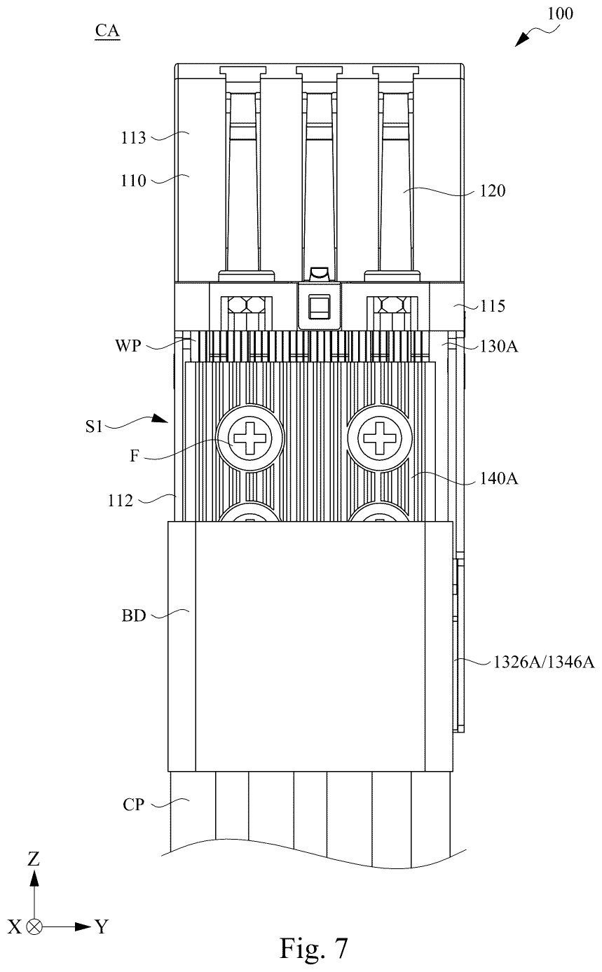

Reference is made to FIG. 7. FIG. 7 is another sided view of the cable harness CA in accordance with an embodiment of the present disclosure. As shown in FIG. 7, in this embodiment, the first space S1 of the housing 110 accommodates the positive cable module CP, one of the two isolating sleeves BD, and the wire fixing module 140A. The wire fixing module 140A is exposed in the first space S1. A portion of the positive wires WP is exposed in the first space S1. The first dissipation fins 1326A are exposed in the first space S1, as well. Similarly, the second space S2 of the housing 110 accommodates the negative cable module CN, the other one of the two isolating sleeves BD, and the wire fixing module 140B. The wire fixing module 140B is exposed in the second space S2. A portion of the negative wires WN is exposed in the second space S2, as well.

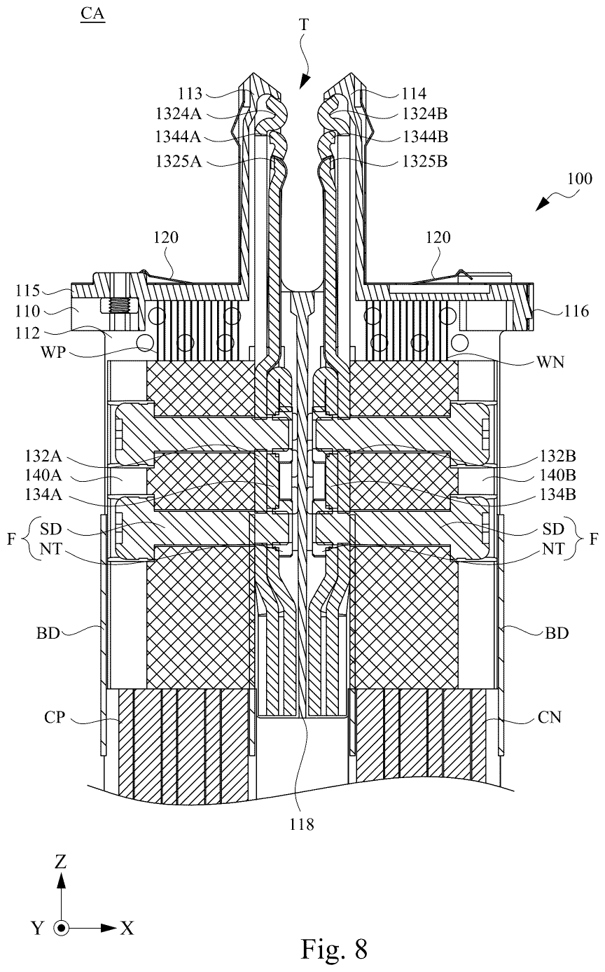

Reference is made to FIG. 8. FIG. 8 is a cross-sectional view of the cable harness CA in accordance with an embodiment of the present disclosure. As shown in FIG. 8, in this embodiment, the fixing part sets F pass through the fixing holes H of the outer terminal plate 132A and the fixing holes H of the inner terminal plates 134A. Similarly, the another fixing part sets F pass through the fixing holes H of the outer terminal plate 132B and the fixing holes H of the inner terminal plates 134B. Each of the fixing part sets F includes a stud SD and a nut NT connected to the stud SD. The stud SD passes though the wire fixing module 140A, the outer terminal plate 132A, and the inner terminal plate 134A. Similarly, the stud SD passes though the wire fixing module 140B, the outer terminal plate 132B, and the inner terminal plate 134B. In some embodiments, the nut NT is located at an end of the stud SD facing the partition plate 118.

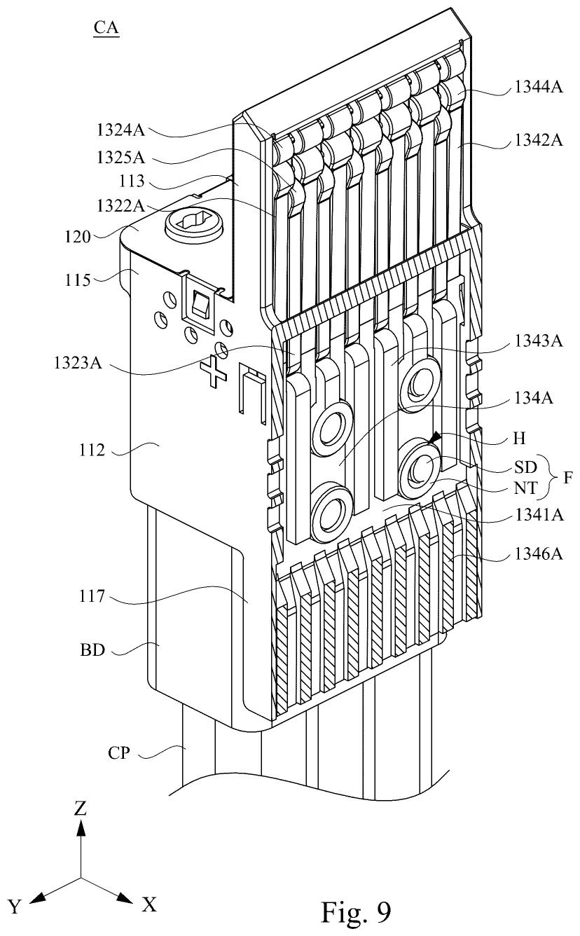

Reference is made to FIG. 9. FIG. 9 is a perspective view of the cable harness CA in accordance with an embodiment of the present disclosure. As shown in FIG. 9, in this embodiment, the nut NT fits in the fixing holes H of the inner terminal plate 134A. The nut NT is located between the extruded portions 1343A. In some embodiments, a thickness of the nut NT is less than a thickness of the extruded portions 1343A in a direction (e.g., x-direction).

As shown in FIG. 9, in some embodiments, a bottom portion of the positive terminal set 130A and the negative terminal set 130B (e.g., the second dissipation fins 1346A) extends beyond the cover plate 112. In some embodiments, the two extending plates 117 extend beyond over half length of a transverse surface of the isolating sleeves BD and a bottom portion of the positive terminal set 130A and the negative terminal set 130B.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A cable harness, comprising:
a connector, having a housing with an inner chamber, the housing comprising:
two cover plates;
two extending portions, having two openings facing to each other, extending away from the two cover plates; and
a partition plate disposed in the inner chamber, the partition plate connecting the two cover plates, for separating the inner chamber into a first space and a second space, the first space being interconnected with one of the two openings of the two extending portions, the second space being interconnected with the other one of the two openings of the two extending portions, the first space having a first lateral opening, the second space having a second lateral opening;
two terminal sets, at least one portion of the two terminal sets being disposed in the housing and the at least one portion of the two terminal sets exposing via the two openings of the two extending portions respectively;
a first cable module, electrically connected to one of the two terminal sets, at least one portion of the first cable module being embedded in the first space and exposing via the first lateral opening, the first cable module comprising:
a plurality of first cables; and
a first wire fixing module comprising a first crimping ring, crimping a plurality of core wires of the plurality of first cables, the first wire fixing module being secured with the one of the two terminal sets by at least one first fixing part set; and
a second cable module, electrically connected to the other one of the two terminal sets, embedded in the second space and exposing via the second lateral opening, the second cable module comprising:
a plurality of second cables; and
a second wire fixing module comprising a second crimping ring crimping a plurality of core wires of the plurality of second cables, the second wire fixing module being secured with the other one of the two terminal sets by at least one second fixing part set.

2. The cable harness of claim 1, further comprising two grounding terminals disposed on the housing, wherein the two grounding terminals are not electrically connected with the two terminal sets.

3. The cable harness of claim 1, wherein the first wire fixing module further comprises a plurality of heat fins secured on a surface of the first crimping ring by the first fixing part set, and the heat fins face the first lateral opening and are exposed via the first lateral opening.

4. The cable harness of claim 1, wherein an end of the core wires of the first cables extends beyond the first wire fixing module and is exposed via the first lateral opening.

5. The cable harness of claim 1, wherein the first cable module has an isolating sleeve covering at least one portion of the first cables and the first wire fixing module.

6. The cable harness of claim 5, wherein the housing further comprises two extending plates extending from the two cover plates toward a direction away from the two extending portions, the two extending plates are connected to both sides of the partition plate to form an H-shaped structure, the two extending plates and the partition plate extend beyond the whole of the first wire fixing module and the second wire fixing module.

7. The cable harness of claim 6, wherein a bottom portion of the two terminal sets extends beyond the two cover plates and the two extending plates extend beyond over half length of a transverse surface of the isolating sleeve and a bottom portion of the two terminal sets.

8. The cable harness of claim 7, wherein each of the two cover plates has a through hole matrix for allowing air to pass therethrough.

9. The cable harness of claim 8, wherein the partition plate extends away from the two extending portions and isolates the first cable module from the second cable module.

10. The cable harness of claim 1, wherein each of the two terminal sets comprises two stacked terminal plates, an end of the two stacked terminal plates forms a plurality of dissipation fins with multiple parallel grooves formed by a stamping process.

11. The cable harness of claim 10, wherein the dissipation fins of one the two stacked terminal plates at an inner side are spaced apart from the dissipation fins of one the two stacked terminal plates at an outer side.

12. The cable harness of claim 11, wherein the two stacked terminal plates comprise a plurality of elastic arms separated by a plurality of gaps, and a plurality of extruded portions are connected to a root of the gaps and bent backward and pressed against the two cover plates, and wherein the two cover plates connect the elastic arms and the dissipation fins at both ends thereof.

13. A cable harness, comprising:
a connector having a housing, the housing having an inner chamber, comprising:
two cover plates;
two extending portions, having two openings facing to each other, extending away from the two cover plates; and
a partition plate disposed in the inner chamber, the partition plate connecting the two cover plates, for separating the inner chamber into a first space and a second space, the first space having a first lateral opening, the second space having a second lateral opening;
two terminal sets, at least a portion of both of the terminal sets being disposed in the housing;
a first cable module, electrically connected to one of the two terminal sets, embedded in the first space and exposing via the first lateral opening, the first cable module comprising:
a plurality of first cables; and
a first wire fixing module comprising a first crimping ring crimping a plurality of core wires of the plurality of first cables, the first wire fixing module being secured with the one of the two terminal sets by at least one first fixing part set; and
a second cable module, electrically connected to the other one of the two terminal sets, embedded in the second space and exposing via the second lateral opening, the second cable module comprising:
a plurality of second cables; and
a second wire fixing module comprising a second crimping ring crimping a plurality of core wires of the plurality of second cables, the second wire fixing module being secured with the other one of the two terminal sets by at least one second fixing part set,
wherein each of the two terminal sets comprises two stacked terminal plates.

14. The cable harness of claim 13, further comprising two grounding terminals disposed on an outside surface of the two extending portions, wherein the two grounding terminals are separated from the two terminal sets.

15. The cable harness of claim 13, wherein the first wire fixing module further comprises a plurality of heat fins secured on a surface of the first crimping ring facing the first lateral opening by the first fixing part set, and the heat fins are exposed via the first lateral opening.

16. The cable harness of claim 13, wherein an end of the core wires of the first cables extends beyond the first wire fixing module and are exposed via the first lateral opening.

17. The cable harness of claim 13, wherein the first cable module has a isolating sleeve covering at least one portion of the first cables and the first wire fixing module.

18. The cable harness of claim 17, wherein one of the two cover plates further comprises an extending plate extending from the one of the two cover plates toward a direction away from the two extending portions, the extending plate is connected to and covering the whole of partition plate, and the extending plate and the partition plate protrude beyond the two cover plates and over half of the isolating sleeve.

19. The cable harness of claim 18, wherein the extending plate covers over half length of a transverse surface of the isolating sleeve and the whole of the two terminal sets, the partition plate extends away from the two extending portions and separates the first wire fixing module from the second wire fixing module.
